(19) United States
(12) Patent Application Publication
(10) Pub. No.: US 2012/0255329 A1
(43) Pub. Date: Oct. 11, 2012

(54) DRAIN HOSE FOR A WASHER

(75) Inventor: Napat Wanweerakul, Trent Woods, NC (US)

(73) Assignee: BSH HOME APPLIANCES CORPORATION, Huntington Beach, CA (US)

(21) Appl. No.: 13/080,871

(22) Filed: Apr. 6, 2011

(51) Int. Cl. D06F 37/00; F16L 11/00

(52) U.S. Cl. 68/208; 138/121

(57) ABSTRACT

A drain hose for a household appliance in which the drain hose includes a first open end, a second open end, and a continuous portion extending from the first open end to the second open end, wherein the continuous portion includes a first bending portion having a plurality of repeating profiles, wherein a cross-section of each profile includes a ridge and a trough, and wherein one of the ridge has three predetermined bending points, and the trough has two predetermined bending points.

### CROSS-REFERENCE TO RELATED APPLICATIONS

This application is related to applicant's co-pending U.S. application, which is filed concurrently herewith, titled “DRAIN HOSE CLIP FOR A WASHER”, Attorney Docket No. 2011P00378US, which is incorporated herein by reference in its entirety.

### FIELD OF THE INVENTION

The present invention is directed to a drain hose for a household appliance, and a household appliance having a drain hose, and more particularly, to a drain hose having a flex-section having a plurality of repeating cross-sectional profiles, wherein each profile includes a ridge and a trough.

### BACKGROUND OF THE INVENTION

A household appliance, such as a front-loading clothes washer, includes a housing supported by a structure, such as a floor. A door provides access to a washing unit in the interior of the appliance housing. The washing unit includes a tub having a cylindrical washing drum rotatably mounted inside the tub. In operation, clothes or laundry are inserted into the washer through the door and placed in the rotating washing drum inside the tub. The household appliance wets the laundry to be washed with washing liquid and mechanically moves the laundry to release contaminants from the laundry. A drive system rotates the washing drum inside the tub about an axis of the drum.

The washer can remove dirt from laundry with washing, rinsing, and spinning cycles using detergent and water. The washer commonly includes a drain pump for pumping out washing or rinsing liquid from the tub to an exterior (e.g., an external drain facility), and a drain hose that connects the drain pump and the external drain facility, such as a drain pipe, for discharging the washing or rinsing liquid pumped by the drain pump to the exterior.

In the past, conventional drain hose assemblies commonly have included two individual drain hoses, one plastic connector, and two hose clamps. These conventional systems commonly require pre-assembly of an internal (first) drain hose to a first side of a plastic connector with a first metal clamp before the drain hose is installed in the washer. The installation of such a conventional drain hose assembly can be burdensome, time consuming, and costly. Additionally, with the conventional drain hose assembly, the user of the washer commonly will have to install an external (second) drain hose to the other side (second side) of the plastic connector with a second metal clamp prior to using the washer.

Recently, a continuous one-piece drain hose has been provided to reduce the total number of components in the draining system, thereby reducing or minimizing costs and assembly time. A one-piece drain hose may simplify the installation of the drain hose by the manufacturer, thereby reducing the labor, time, and expense associated with the drain hose, while also reducing the time and effort on the part of the user to connect the drain hose to a drain pipe when installing the washer.

During the assembly process of the washer, a first open end of the drain hose is coupled to the housing of the drain pump inside the washer housing. The continuous drain hose may then be inserted through an opening in the rear panel of the washer housing to the exterior of the washer. In this manner, when the washer is being installed by the consumer, the drain hose is already coupled to the drain pump of the washer and the user simply positions the second open end (distal end) of the hose into an external drain pipe.

In order to connect the drain hose to the drain pump inside the washer and then extend the drain hose through the rear panel of the washer to the exterior, the drain hose commonly must be routed through open areas inside of the washer and then bent in an arch shape in order to route the drain hose from inside the housing and through an opening in the rear panel of the washer housing to the exterior. The internal clearance within the housing of the washer for routing the drain hose may be limited or restricted depending on the arrangement of the drain pump, drain hose, and other components of the washer. Thus, one or more portions of the drain hose commonly must be bent by, for example, 90˜180 degrees from its original straight shape.

Additionally, the packaging materials used to protect and ship the washer from the manufacturer to the customer may provide limited or restricted clearance on the outside of the washer housing for routing the portion of the drain hose that extends from the rear panel of the washer housing. Thus, another portion of the drain hose that is outside of the housing of the washer commonly must be bent in an arch shape by, for example, 90˜180 degrees from its original straight shape in order to avoid interference with the packing materials used to protect and transport the washer from the manufacturer to the customer.

In order to facilitate the bending of the drain hose, the conventional continuous drain hose commonly is formed from a corrugated plastic hose pattern having a wave pattern or a spiral pattern that may be formed by casting or molding. For example, as illustrated in FIG. 1, the conventional drain hose commonly includes a corrugated hose 10 having a plurality of rings 12 formed by a repeating profile of ridges 14 and troughs 16. The profiles commonly may include a flat ridge 14 and a U-shaped trough 16, or triangular shaped ridges and troughs.

As schematically illustrated in FIG. 2, when a conventional drain hose is flexed or bent in an arch shape, for example by 90˜180 degrees, one side of the plastic drain hose 10 expands or stretches, while the other side is compressed or crushed, thereby exposing portions of the drain hose to different amounts of stress and strain. For example, as shown in FIG. 2, the portions of the drain hose that are exposed to higher degrees of crushing and expansion typically are exposed to a greater amount of stress (e.g., S1, S2) than other areas (e.g., S3, S4, S5). Such high stress areas may be susceptible or more prone to failure or leaking, for example, over time.

### SUMMARY OF THE INVENTION

The present invention recognizes that, during bending, in addition to the amount of stress on the drain hose varying based on the amount of crushing or expansion, the amount of stress acting on portions of the drain hose varies based on the profile of the rings of the corrugated section of the drain hose. More particularly, the amount of stress may be different for different portions of each profile of the rings.

For example, an amount of stress commonly is greater in areas of the profile where bending occurs, such as in the lowermost area of each trough 16 and the uppermost area of each ridge 14 in FIG. 1. As a result, the conventional drain hose may exhibit white stretch marks on each corrugated ring 12 at the section of the hose 10 that is bent. These white stretch marks correspond to locations of stretching/expansion and compressing/crushing, and are an indication of high stress on the material at these areas. Such high stress areas may be susceptible or more prone to failure or leaking, for example, over time.

With reference to FIG. 3, the conventional drain hose 10 may include, for example, a flat ridge 14 and a U-shaped trough 16. The ridge 16 has two bending points b, which are schematically identified by black dots. The trough 16 has a single bending point b, which is similarly identified by a black dot in FIG. 3. The stress resulting from bending the drain hose, for example 90˜180 degrees, is concentrated at these bending points b, which may lead to large amounts of stress at these locations and in some cases cracking or tearing of the drain hose.

The present invention also recognizes that routing the drain hose and flexing or bending the drain hose during the installation process may result in the drain hose being twisted or otherwise disoriented such that the drain hose is not oriented in a proper position for installation into a drain pipe by the consumer.

These problems and others are addressed by the present invention, a first exemplary embodiment of which comprises a drain hose for a washer, the drain hose comprising a first open end, a second open end, a continuous portion extending from the first open end to the second open end, wherein the continuous portion includes a first bending portion having a plurality of repeating profiles, wherein a cross-section of each profile includes a ridge and a trough, and wherein one of the ridge has at least three predetermined bending points and the trough has at least two predetermined bending points.

In an exemplary embodiment, the ridge has at least three predetermined bending points and the trough has at least two predetermined bending points. In other embodiments, each of the ridge and the trough has at least three predetermined bending points.

The cross-section of each profile can include a leg portion connecting the ridge and trough, wherein a first end of the leg portion is connected to the ridge by a first radius portion, and wherein a second end of the leg portion is connected to the trough by a second radius portion. More particularly, the ridge can include a first curved portion and the trough can include a second curved portion, wherein the cross-section of each profile further includes a tangential portion connecting the first curved portion to the second curved portion, a first radius transitioning from the first curved portion to a first end of the tangential portion, and a second radius transitioning from the second curved portion to a second end of the tangential portion.

The continuous portion of the drain hose can include a second bending portion having a plurality of second repeating portions, which may be similar to the repeating portions of the first bending portion. The continuous portion can include a straight portion coupling the first bending portion to the second bending portion. The straight portion can include a mating surface for receiving a drain hose clip that secures the drain hose to the household appliance. The straight portion also can include one or more alignment elements, such as one or more projections extending from a surface of the straight portion, wherein the one or more alignment elements provides a predetermined orientation of the drain hose with respect to a drain hose clip that is coupled to the household appliance. The one or more alignment elements can engage with the clip only one way, thereby ensuring a proper alignment and orientation of the drain hose with the clip.

The drain hose can include a first corrugated portion disposed on an opposite side of the first bending portion from the straight portion and between the first bending portion and the first open end, and a second corrugated portion disposed on an opposite side of the second bending portion from the straight portion and between the second bending portion and the second open end. The first open end or the second open end can have a pump alignment element for engaging a corresponding pump alignment feature of a pump housing.

In an embodiment, the household appliance is a washer having a drain pump including a pump housing.

Another exemplary embodiment of the invention comprises a household appliance, such as a washer, including a housing having a front wall and a rear panel, the housing having a door formed in the front wall for accessing an interior of the housing, a tub disposed inside the housing, a rotatable drum within the tub and having an axis of rotation, the rotatable drum for receiving laundry through the door, a drain pump disposed inside the housing, and a drain hose including a first open end, a second open end, a continuous portion extending from the first open end to the second open end, wherein the continuous portion includes a first bending portion having a plurality of repeating profiles, wherein a cross-section of each profile includes a ridge and a trough, and wherein one of the ridge has at least three predetermined bending points, and the trough has at least two predetermined bending points.

In this embodiment, the first open end of the drain hose is coupled to the pump housing and the second open end of the drain hose is disposed outside of the housing.

The housing includes an opening in the rear panel, and the drain hose extends through the opening. In an assembled state, the first bending portion can be disposed adjacent to the rear panel of the housing and inside the housing, and the second bending portion can be disposed adjacent to the rear panel of the housing and outside the housing. The straight portion can be disposed in the opening of the rear panel.

In an embodiment, the opening forms a fitting support, and the household appliance comprises a clip secured to the fitting support. The straight portion can include a mating surface engaging the clip to secure the drain hose to the fitting support of the rear panel. For example, the clip can include a first alignment element and the straight portion of the drain hose can include a second alignment element, such that the first alignment element of the clip engages the second alignment element of the drain hose to provide a predetermined orientation of the drain hose with respect to the clip.

In this manner, the exemplary embodiments of the drain hose can distribute stress applied to the drain hose during bending, for example of 90˜180 degrees, over a larger number of bending points, thereby reducing or minimizing an amount of stress at each bending point, and reducing, minimizing, or eliminating the potential for failure or leaking, for example, over time. The exemplary embodiments dramatically reduce the stress and strain on the ridge and trough of each profile as compared to the stress on the conventional drain hose. Additionally, the exemplary embodiments can reduce the stress and strain on the areas that are exposed to higher degrees of crushing and expansion, as compared to the stress on the conventional drain hose, as shown in FIG. 2.

The exemplary embodiments of the drain hose can include one or more flex portions having greater flexibility than other portions (e.g., normal corrugated portions) of the drain hose. In this manner, a portion of the drain hose that is positioned adjacent to the opening in the rear panel of the housing can have a greater flexibility than a remaining portion of the drain hose, which may be less flexible while still maintaining sufficient or acceptable flow through the drain hose. In an embodiment, only the portion of the drain hose that is adjacent the rear panel of the housing includes a portion which has a higher degree of flexibility, thereby permitting the drain hose to be bent substantially 90˜180 degrees at this location without damaging the drain hose.

The exemplary drain hose includes a corrugated pattern having a predetermined profile that provides greater flexibility at a portion intended for a higher degree of bending than for portions where a lesser degree of bending is needed to position the hose in the washer. For purposes of this disclosure, the portion having such a predetermined profile for providing greater flexibility will be referred to as a “flex section.” The area of lesser degree of bending can have a profile similar to the conventional corrugated profile shown in FIG. 1, and will be referred to as a “normal corrugation section.”

The exemplary embodiments of the drain hose having the flex section can reduce bending stress on each point and also increase the flexibility of this portion of the drain hose, such that the flex section of the drain hose can be bent by about 90 degrees or more while minimizing or eliminating a risk of damaging the drain hose, such as creating a crack/tear.

The exemplary embodiments also can provide a continuous, one-piece drain hose having a double-flex feature which can improve flexibility and save space inside the washer and outside the washer for providing sufficient clearance for product packaging. In this manner, a flex section can be located on both the inside and outside connection points to the drain hose clip for coupling the drain hose to an opening in the rear panel of the washer housing. By providing a drain hose having a flex-section, or a double-flex section, the drain hose according to the exemplary embodiments can be assembled in an area inside the housing of washer having limited space. The drain hose according to the exemplary embodiments also enables the drain hose to be routed on the outside of the rear panel of the washer housing within a limited space between the rear panel and the packaging for shipping the washer.

The double-flex section of the drain hose can include a straight section (i.e., non-bendable or low flexibility section) interposed between two flex sections. In this manner, the straight section can engage and be coupled to a drain hose clip or the like for securing the drain hose to the opening in the rear panel of the washer housing.

The straight section can include one or more orientation features for ensuring a correct orientation of the drain hose with respect to a drain hose clip or the like for securing the drain hose to the opening in the rear panel of the washer housing. For example, the straight section can include two orientation features for engaging corresponding orientation features on a drain hose clip, thereby ensuring a correct orientation of the drain hose with respect to a drain hose clip. The orientation features can be different such that there is only a single way to connect the drain hose clip to the drain hose, thereby further ensuring that the drain hose clip is properly orientated with respect to the drain hose and the rear panel of the washer housing.

The drain hose includes a first open end for coupling to a housing of a drain pump inside the washer. The pump housing can include a fitting having an orientation feature, such as a key, tab, projection, or the like. The first open end of the drain hose can include a corresponding orientation feature, such as a ring portion having an opening section that engages the orientation feature of the pump housing. The corresponding orientation features can ensure that the drain hose is installed in the correction orientation to avoid or prevent twisting of the drain hose when the drain hose is coupled to the rear panel of the appliance by, for example, a drain hose clip or the like in an assembled state.

An exemplary method of installing the drain hose can include a step of feeding the drain hose from the outside of the washer through an opening or cutout on the rear panel of the appliance. Next, a drain hose clip can be coupled to the drain hose, for example by snap-fitting the drain hose clip to the drain hose at the straight portion of the drain hose. The orientation features on the drain hose clip and the drain hose can ensure that the drain hose will be oriented properly for correct installation on the pump housing of the drain pump. The drain hose clip is then aligned with the cutout or opening in the rear panel of the housing and pushed into the opening in the housing until the drain hose clip snaps and locks in place. The drain hose clip can be configured to be inserted into the opening in the housing, for example, from the interior side of the housing or the exterior side of the housing, or in other embodiments, from both the interior and exterior side of the housing, for example, if the drain hose clip is formed from separate pieces. The first open end of the drain hose is then coupled to the housing of the drain pump. As explained above, the corresponding orientation features of the drain hose and the pump fitting can further ensure that the drain hose is correctly aligned to avoid twisting of the drain hose. The drain hose can then be secured to the inside of the rear panel of the housing using, for example, a side panel clip. Next, the drain hose can be routed and secured to the rear panel of the housing at a second location using another hose clip or hose support. The drain hose can remain in this secured state during packaging and shipping to prevent damage to the drain hose. After the washer is delivered to a user and the packaging is removed, the user simply can remove the hose from the second hose clip or support and position the second open end (distal end) of the hose into an external drain pipe to complete the installation of the drain hose.

The exemplary embodiments also can provide a continuous, one-piece drain hose and fitting support assembly that ensures that the first open end of the drain hose is properly aligned and oriented with the drain pump in the washer, while also ensuring that the drain hose is properly aligned and oriented with the fitting support, and properly aligned and oriented for insertion into a drain pipe located exterior to the washer.

The exemplary embodiments of the drain hose and the drain hose clip can control the orientation of the drain hose and the drain hose clip with respect to each other, as well as to the opening in the rear panel of the washer housing. The drain hose clip also can reduce or prevent movement of the drain hose into and out of the opening in the rear panel of the washer housing, thereby reducing or preventing damage from the drain hose rubbing against the housing or the opening of the housing.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a side, cross-sectional view of a conventional drain hose.

FIG. 2 is a schematic illustration of bending stress in a conventional drain hose.

FIG. 3 is a partial side, cross-sectional view of a normal corrugated section of the conventional drain hose of FIG. 1.

FIG. 4A is a schematic side view of a drain hose according to an exemplary embodiment of the invention.

FIG. 4B is a partial side view of a drain hose of the drain hose of FIG. 4A.

FIG. 4C is a partial side, cross-sectional view of a flex-section of the drain hose of FIG. 4A.

FIG. 4D is a partial side, cross-sectional view of a normal corrugated section of the drain hose of FIG. 4A.

FIG. 5 is a side, cross-sectional view of a drain hose according to an exemplary embodiment of the invention.

FIG. 6 is an enlargement of a partial side, cross-sectional view of a profile of the drain hose of FIG. 5.

FIG. 7 is a partial perspective view of a drain hose according to an exemplary embodiment of the invention.

FIG. 8A is a partial perspective view of a drain hose clip and a drain hose according to an exemplary embodiment of the invention.

FIG. 8B is another partial perspective view of a drain hose clip and a drain hose according to an exemplary embodiment of the invention.

FIG. 9A is a partial perspective assembly view of a rear panel of a washer housing and a drain hose according to an exemplary embodiment of the invention.

FIG. 9B is another partial perspective assembly view of a drain hose clip and drain hose according to an exemplary embodiment of the invention.

FIG. 9C is a partial perspective assembly view of a rear panel of a washer housing and an assembled drain hose clip and drain hose according to an exemplary embodiment of the invention.

FIG. 10 is a partial perspective view of an interior of a rear panel of a washer housing and an assembled drain hose clip and drain hose according to an exemplary embodiment of the invention.

FIG. 11 is a partial side view of an exterior of a rear panel of a washer housing and a drain hose according to an exemplary embodiment of the invention.

FIG. 12 is another partial perspective view of an interior of a rear panel of a washer housing and an assembled drain hose clip and drain hose according to an exemplary embodiment of the invention.

FIG. 13 is another partial perspective view of an exterior of a rear panel of a washer housing and an assembled drain hose clip and drain hose according to an exemplary embodiment of the invention.

FIG. 14 is another partial perspective view of an interior of a rear panel of a washer housing and an assembled drain hose clip and drain hose according to an exemplary embodiment of the invention.

FIG. 15 is another partial perspective view of an exterior of a rear panel of a washer housing and an assembled drain hose clip and drain hose according to an exemplary embodiment of the invention.

FIG. 16A is a perspective view of a drain pump of a washer and a first open end of the drain hose according to an exemplary embodiment of the invention.

FIG. 16B is a side view of a drain pump of a washer and a first open end of the drain hose according to an exemplary embodiment of the invention.

FIG. 17 is schematic front view of a washer according to an exemplary embodiment of the invention.

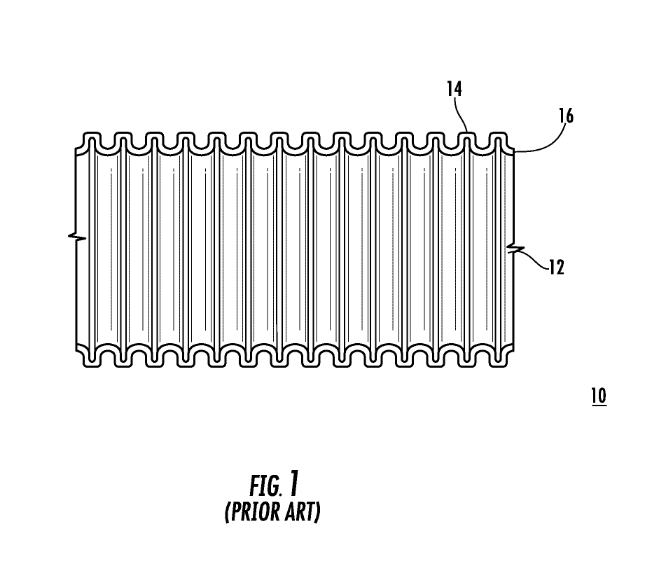

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

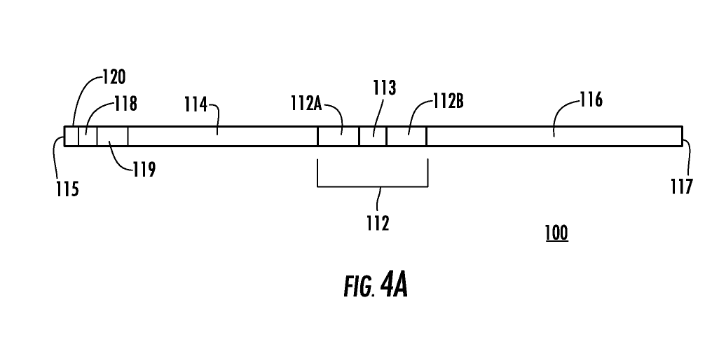

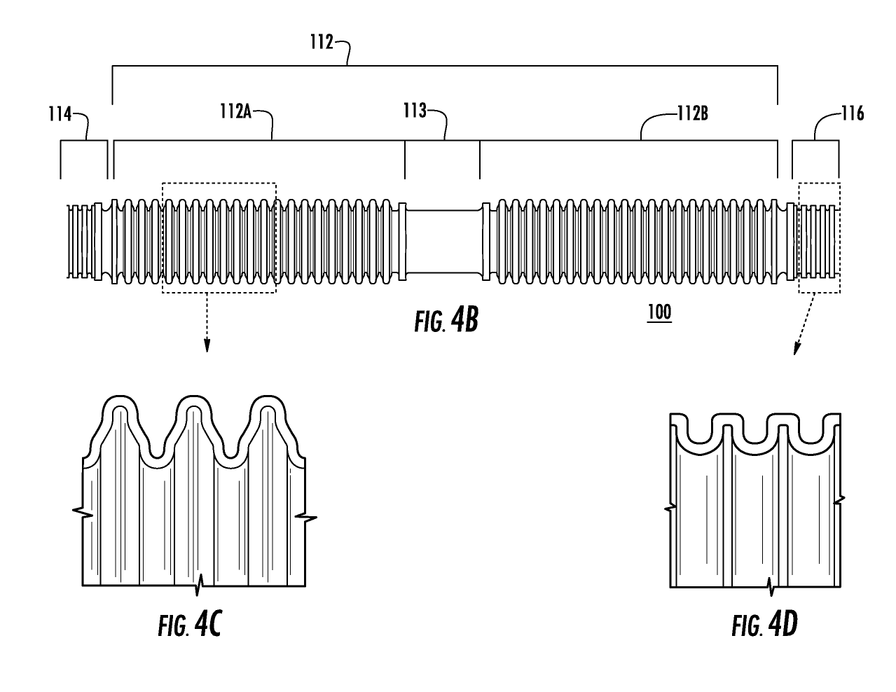

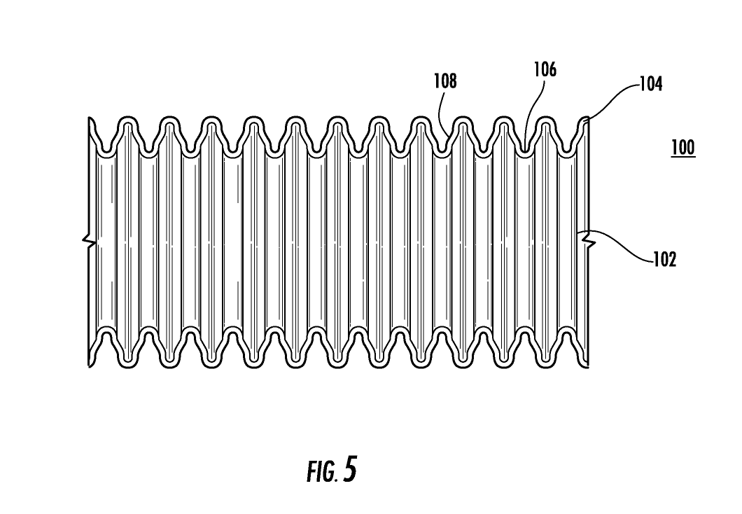

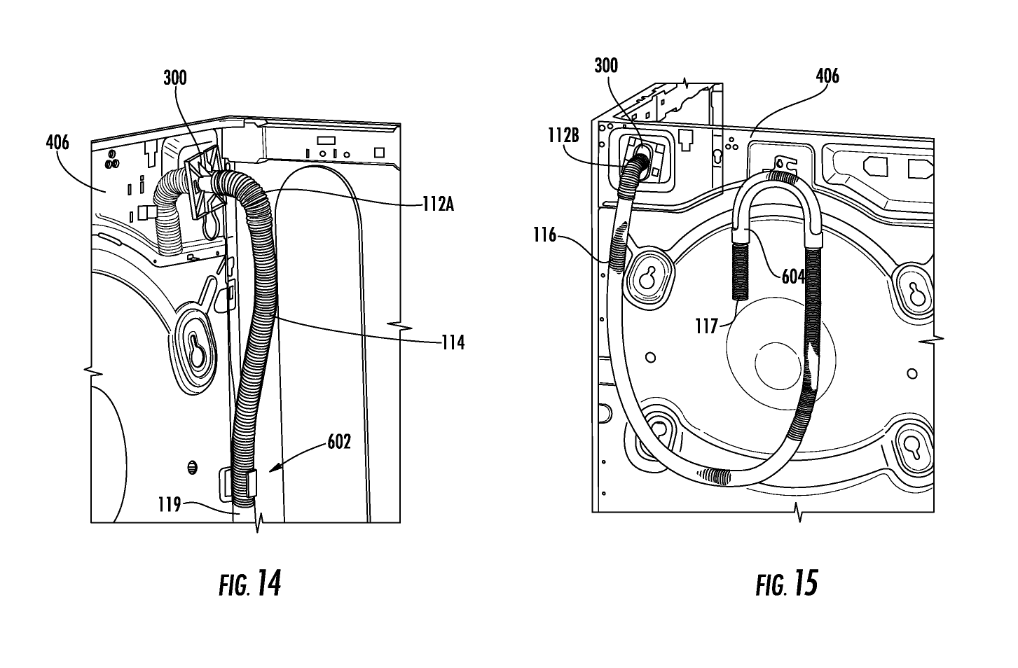

Referring now to the drawings, FIGS. 4-17 illustrate exemplary embodiments of a drain hose and a household appliance, such as a washer, having a drain hose.

An exemplary embodiment of a continuous, one-piece drain hose 100 will now be described with reference to FIGS. 4A-6.

As shown in FIGS. 4A-4D, an exemplary embodiment of the drain hose 100 can include a first open end 115, a second open end 117, a continuous portion extending from the first open end 115 to the second open end 117. The continuous portion can include a continuous, one-piece construction having a flex section (e.g., double-flex section 112) which can improve flexibility and save space inside the washer and outside the washer for providing sufficient clearance for product packaging. The drain hose 100 can include normal corrugation sections (e.g., 114, 116) between the double flex-section 112 and the open ends 115, 117 of the drain hose 100, as shown for example in FIG. 4D.

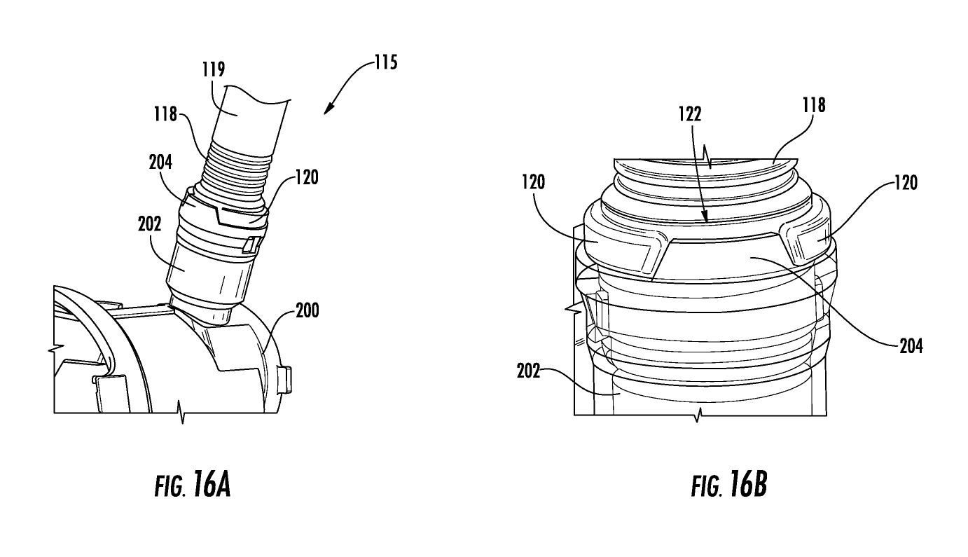

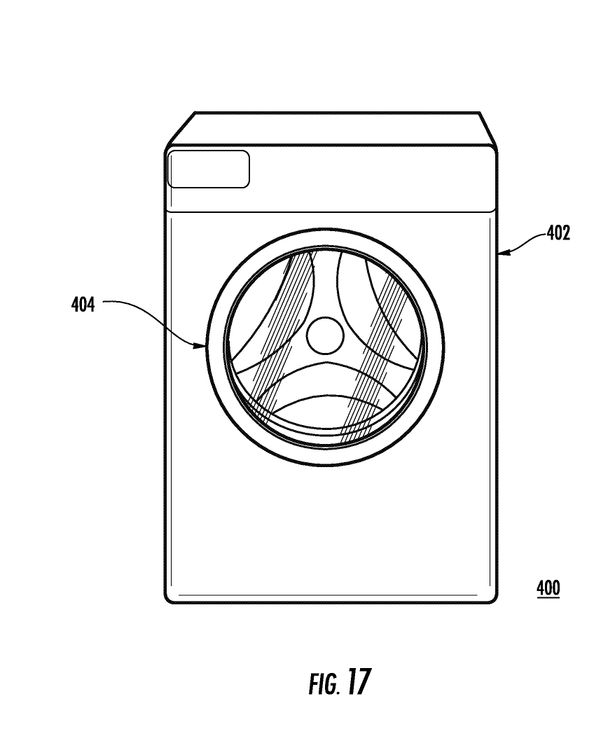

The first open end 115 of the drain hose 100 can be configured for coupling to a pump housing of a drain pump inside the washer (described in greater detail below with reference to FIGS. 16A and 16B). For example, the first open end 115 of the drain hose 100 can include an orientation feature, such as a ring portion 120, that engages a corresponding orientation feature of the pump housing, thereby ensuring that the drain hose 100 is installed in the correction orientation to avoid or prevent twisting of the drain hose 100 when the drain hose 100 is coupled to the rear panel of an appliance in an assembled state. The second open end 117 can be configured for insertion into, or coupling with, an external drain pipe (not shown).

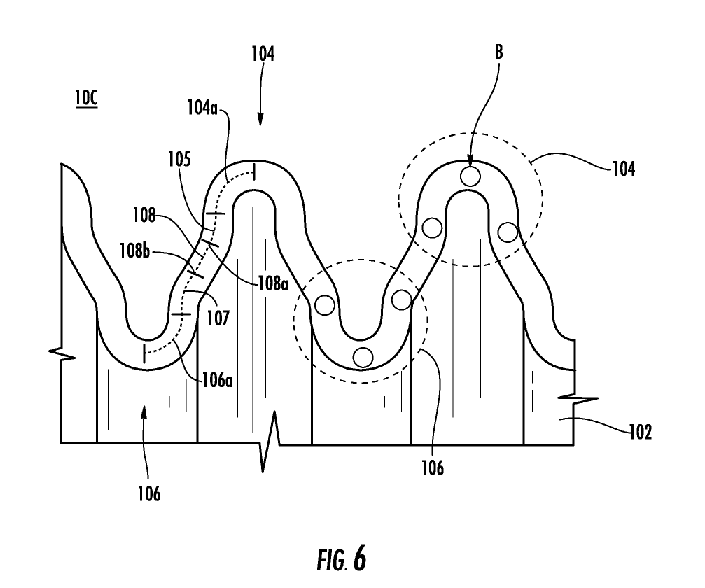

As exemplarily illustrated in FIGS. 4A, 4B, and 4C, the double-flex section 112 can include a first flex section 112A having a plurality of first repeating profiles, wherein a cross-section of each profile includes a ridge 104 and a trough 106 (described in more detail with reference to FIGS. 5 and 6), and wherein the ridge 104 has at least three predetermined bending points and/or the trough 106 has at least two predetermined bending points. The double-flex section 112 of the drain hose 100 also can include a second flex section 112B having a plurality of second repeating profiles, which may be similar to the repeating profiles of the first flex section 112A. Alternatively, the second flex section 112B can include a plurality of second repeating profiles that are different from the first repeating profiles of the first flex section 112A.

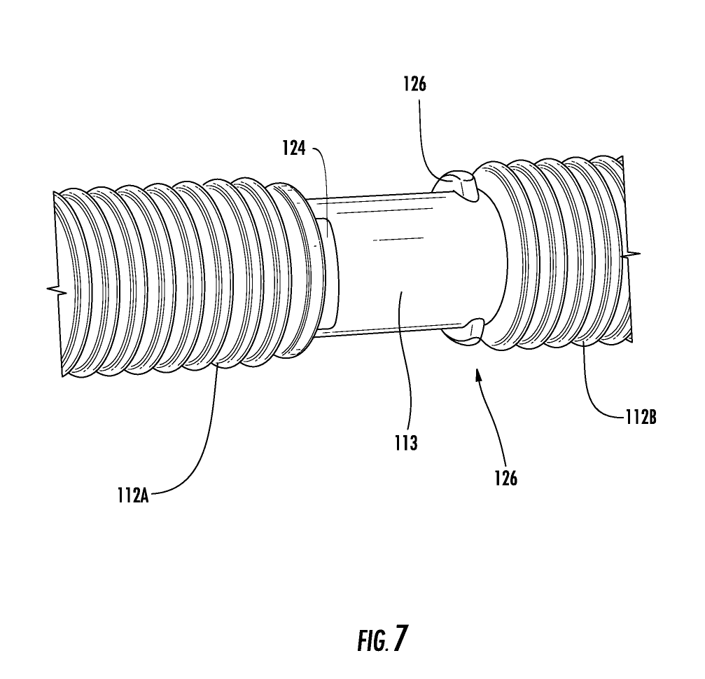

In an exemplary embodiment, the double-flex section 112 of the drain hose also can include a straight section 113 (i.e., a non-bendable or low flexibility section, or non-corrugated section) interposed between the two flex sections 112A, 112B. The straight portion 113 can include a mating surface (e.g., a smooth cylindrical surface) for receiving a drain hose clip (e.g., 300; described in greater detail with reference to FIGS. 7-15) to secure the drain hose 100 to a household appliance.

The drain hose 100 can include one or more additional straight sections (i.e., non-corrugated sections), such as a straight section 119 illustrated in FIG. 4A. In the exemplary embodiment of FIG. 4A, another section 118 having a normal corrugation profile (e.g., similar to the profile of FIG. 4D) can separate the straight section 119 from the ring portion 120 of the first open end 115, thereby providing flexibility for positioning and coupling the first open end 115 of the drain hose 100 to a pump housing of a drain pump inside the washer. In another embodiment, the section 118 can be formed from a plurality of repeating rings similar to those of the flex-sections 112A, 112B (shown in FIG. 4C), thereby providing greater flexibility and ease with which the drain hose 100 can be coupled to the drain pump.

With reference to FIGS. 5 and 6, an exemplary embodiment of the double-flex section 112, including one or more flex-sections 112A, 112B having a plurality of repeating rings 102, will now be described. As shown in FIGS. 5 and 6, each of the rings 102 can include a cross-section having a predetermined profile including a ridge 104 and trough 106. The ridge 104 has three or more predetermined bending points B. Alternatively, the trough 106 has two or more predetermined bending points B. In other embodiments, the ridge 104 has three or more predetermined bending points B and the trough 106 has two or more predetermined bending points B. In other embodiments, each of the ridge 104 and the trough 106 has three or more predetermined bending points B.

As shown by the dashed lines in FIG. 6, the ridge 104 and trough 106 can be connected by a tangential leg portion 108 that is connected between the ridge 104 and the trough 106 by radius portions 105, 107. More particularly, the ridge 104 can include a first curved portion 104a and the trough 106 can include a second curved portion 106a, wherein the cross-section of each profile further includes a tangential portion 108 connecting the first curved portion 104a to the second curved portion 106a, a first radius 105 transitioning from the first curved portion 104a to a first end 108a of the tangential portion 108, and a second radius 107 transitioning from the second curved portion 106a to a second end 108b of the tangential portion 108.

In comparison, with reference again to FIG. 3, the conventional art drain hose 10 includes a ridge 14 having only two bending points b and a trough 16 having only a single bending point b.

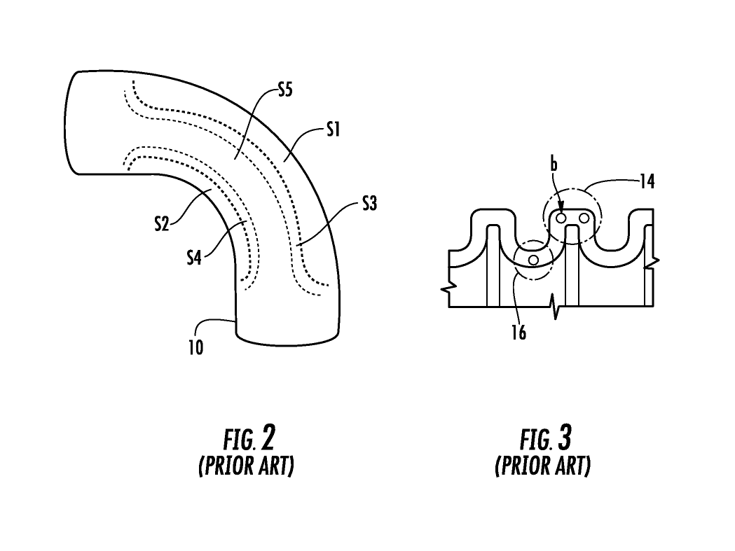

In this manner, the exemplary embodiments of the drain hose 100 can distribute stress applied to the drain hose 100 during bending, for example of 90˜180 degrees, over a larger number of bending points B, thereby reducing or minimizing an amount of stress at each bending point, and reducing, minimizing, or eliminating the potential for failure or leaking, for example, over time. The exemplary embodiments dramatically reduce the stress and strain on the ridge 104 and trough 106 of each profile as compared to the stress on the conventional drain hose 10, as shown for example in FIG. 2. Additionally, the exemplary embodiments can reduce the stress and strain on the areas that are exposed to higher degrees of crushing and expansion, as compared to the stress on the conventional drain hose, as shown in FIG. 2. The flex-sections 112A, 112B can provide greater flexibility than other portions (e.g., normal corrugated portions 114, 116) of the drain hose 100. In this manner, a portion of the drain hose 100 that is positioned adjacent to an opening in the rear panel of an appliance housing can have a greater flexibility (e.g., is easier to bend, bends further, etc. without damaging the drain hose 100) than a remaining portion of the drain hose 100, which may be less flexible while still maintaining sufficient or acceptable flow through the drain hose 100.

In an embodiment, only a portion of the drain hose 100 that is adjacent to the rear panel of the housing includes a portion (e.g., flex-sections 112A, 112B) which has a higher degree of flexibility, thereby permitting the drain hose 100 to be easily bent substantially 90˜180 degrees (or more) at this location without damaging the drain hose 100. In this embodiment, the remaining portions of the drain hose 100 can be formed, for example, from one or more normal corrugation sections (e.g., 114, 116) or one or more straight sections (e.g., 113, 119).

With reference to the exemplary embodiment of FIGS. 7-9C, the straight section 113 of the drain hose 100 can include one or more alignment or orientation features 124, 126 for ensuring a correct orientation of the drain hose 100 with respect to a drain hose clip 300 or the like for securing the drain hose 100 to an opening in a rear panel 406 of the washer housing. For example, the straight section 113 can include two orientation features 124, 126 for engaging corresponding orientation features 304, 306 on a drain hose clip 300, thereby ensuring a correct orientation of the drain hose 100 with respect to a drain hose clip 300. The orientation features 124, 126 can be different such that there is only a single way to connect the drain hose clip 300 to the drain hose 100, thereby further ensuring that the drain hose clip 300 is properly orientated with respect to the drain hose 100 and the rear panel 406 of the washer housing. In an exemplary embodiment, one of the orientation features 124, 126 can include a raised projection or disc portion that extends away from the surface of the straight section 113 and extends partially around a circumference of the straight portion 113. One of ordinary skill in the art will recognize that the orientation features are not limited to the illustrated exemplary embodiments and one or more orientation features can be provided on the drain hose 100 or the drain hose clip 300. The orientation features can be projections or the like that extend from the surface of either the drain hose 100 or the drain hose clip 300, or grooves, channels, or the like that are recessed into the surface of either the drain hose 100 or the drain hose clip 300, or combinations thereof.

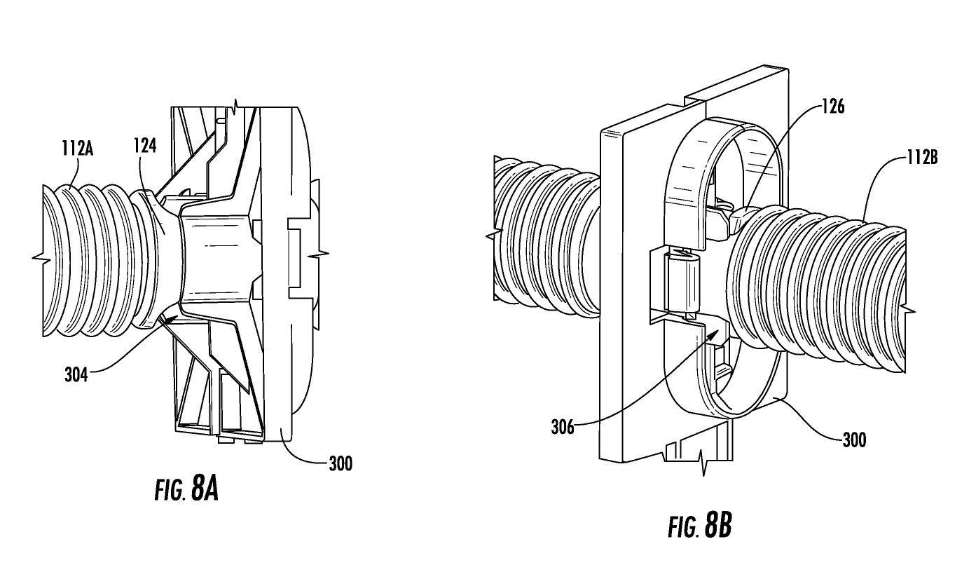

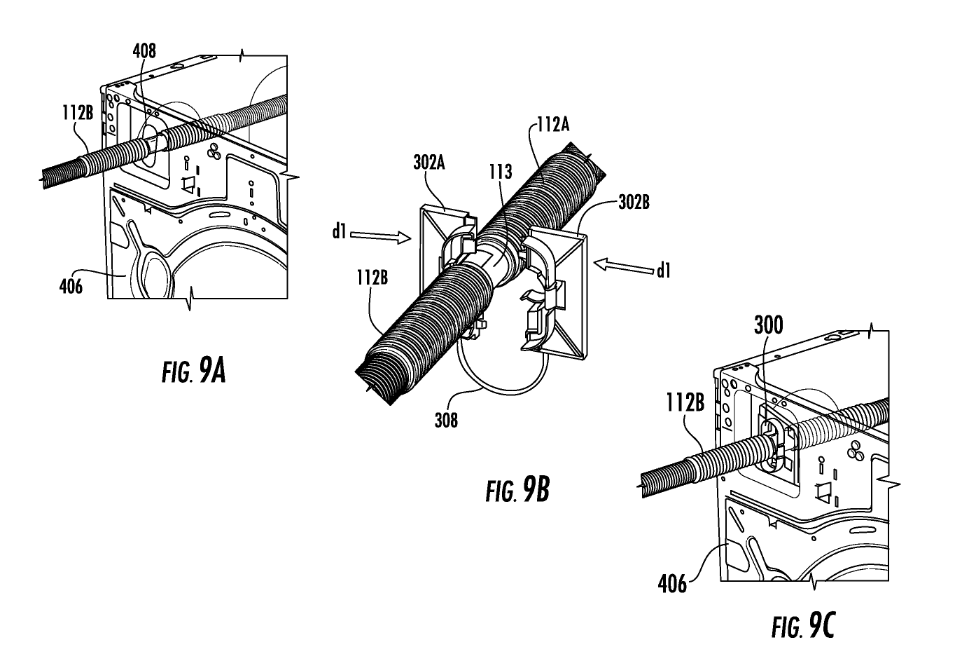

In this manner, the straight section 113 can engage and be coupled to a drain hose clip (e.g., 300 shown in FIGS. 8A and 8B) or the like for securing the drain hose 100 to an opening or fitting support 408 in the rear panel (e.g., 406 shown in FIGS. 9A and 9C) of the washer housing. In FIGS. 9A and 9C, the rear panel is illustrated as being transparent for illustrative and clarification purposes only, such that the arrangement of the drain hose 100 is visible.

In operation, the first open end 115 of the drain hose 100 can be coupled to the housing 202 of the drain pump 200 (as described in more detail below with reference to FIGS. 16A and 16B). The exemplary drain hose 100 can be installed through an opening 408 in the rear panel 406 of the washer housing such that a portion of the drain hose 100 extends outside the housing of the washer. Next, the drain hose clip 300 can be coupled to the straight portion 113 of the drain hose 100.

To simplify the installation of the drain hose 100 into the drain hose clip 300 after the drain hose 100 is inserted into the opening 408 in the rear panel 406 of the washer housing, an exemplary embodiment of the drain hose clip 300 can include a first portion 302A and a second portion 302B that engage each other to form the drain hose clip 300. For example, the first portion 302A and second portion 302B can be coupled around (e.g., wrapped around) the drain hose 100 without having to insert the length of the drain hose 100 through the drain hose clip 300. The first portion 302A and second portion 302B can be separate parts, or the first portion 302A and second portion 302B can be moveably coupled together. For example, the drain hose clip 300 can include a connecting strip 308, or other suitable feature for moveably connecting the first portion 302A and second portion 302B, such as a hinge or the like, for coupling the first portion 302A to the second portion 302B while permitting movement of these portions with respect to each other. In this manner, the first portion 302A and the second portion 302B of the drain hose clip 300 can be slid onto (e.g., around) the drain hose 100, for example from below, while the drain hose 100 is already inserted into the opening 408 in the rear panel 406 of the housing. Next, the drain hose clip 300 can be coupled to the drain hose 100, for example by snap-fitting the first portion 302A to the second portion 302B around the drain hose 100 in a direction d1 at the straight portion 113 of the drain hose 100, as illustrated in FIG. 9B.

The orientation features 304, 306 on the drain hose clip 300 and the corresponding orientation features 124, 126 on the drain hose 100 can ensure that the drain hose 100 will be oriented properly for correct installation of one end of the drain hose 100 on the pump housing 202 of the drain pump 200, or for insertion of the other end of the drain hose 100 into an external drain pipe located adjacent of the washer. The orientation features can be arranged such that the drain hose 100 can be coupled to the drain hose clip 300 in only a single way. One of ordinary skill in the art will recognize that the orientation features are not limited to the illustrated exemplary embodiments and one or more orientation features can be provided on the drain hose 100 or the drain hose clip 300.

Next, the drain hose clip 300 is aligned with the cutout or opening 408 in the rear panel 406 of the housing and pushed into the opening 408 in the housing until the drain hose clip 300 snaps and locks in place, as illustrated in FIG. 9C. The drain hose clip can be configured to be inserted into the opening in the housing, for example, from the interior side of the housing or from the exterior side of the housing, or in other embodiments, from both the interior and exterior side of the housing, for example, if the drain hose clip is formed from separate pieces.

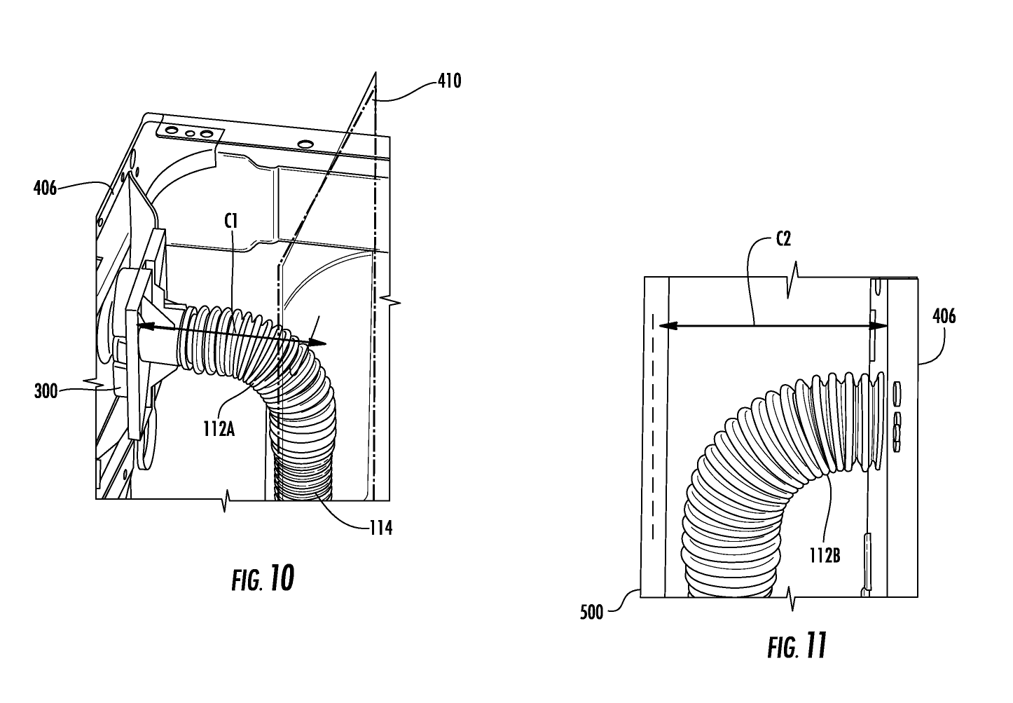

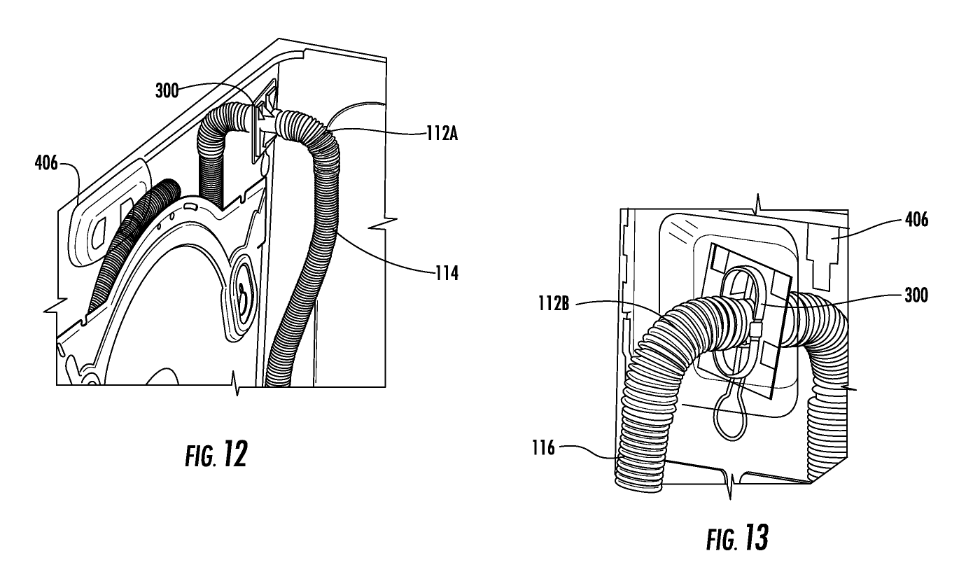

With reference to FIGS. 10-13, the drain hose 100 can be bent substantially 90˜180 degrees (or more) at the flex-sections 112A, 112B such that the drain hose 100 extends along the inside and outside of the rear panel 406 of the housing. By providing a drain hose 100 having a flex-section, or a double-flex section 112, the drain hose 100 according to the exemplary embodiments can be assembled in an area inside the housing of washer having limited space (e.g., clearance C1). The drain hose 100 according to the exemplary embodiments enables the drain hose 100 to be routed on the outside of the rear panel 406 of the washer housing within a limited space (e.g., clearance C2) between the rear panel 406 and the packaging 500 for shipping the washer. In FIGS. 12, 13, and 14, the rear panel is illustrated as being transparent for illustrative and clarification purposes only, such that the arrangement of the drain hose 100 is visible.

As shown in FIG. 14, the drain hose 100 can then be secured to the inside of the rear panel 406 of the housing using, for example, a side panel clip 602 or the like. Next, the drain hose 100 can be routed and secured to the rear panel 406 of the housing at a second location using another hose clip or hose support 604 or the like, as shown in FIG. 15. The drain hose 100 can remain in this secured state during packaging and shipping to prevent damage to the drain hose 100. After the washer is delivered to a user and the packaging is removed, the user simply can remove the second open end 117 of the drain hose 100 from the second hose clip or support 604 and position the second open end 117 (distal end) of the drain hose 100 into an external drain pipe (not shown) to complete the installation of the drain hose 100.

With reference to FIGS. 16A and 16B, the drain hose 100 can include a first open end 115 for coupling to a pump housing 202 of a drain pump 200 inside the washer. The pump housing 202 can include a fitting having an orientation feature 204, such as a key, tab, projection, or the like. The first open end 115 of the drain hose 100 can include a corresponding orientation feature, such as a ring portion 120 having an opening section 122 that engages the orientation feature 204 of the pump housing 202. The corresponding orientation features 120, 122 and 204 can ensure that the drain hose 100 is installed in the correction orientation to avoid or prevent twisting of the drain hose 100 when the drain hose 100 is coupled to the rear panel of an appliance by, for example, a drain hose clip 300 or the like in an assembled state. One of ordinary skill in the art will recognize that the orientation features are not limited to the illustrated exemplary embodiments and one or more orientation features can be provided on the drain hose 100 or the fitting of the housing 202, the drain pump 200, etc.

The drain hose 100 can include one or more additional straight sections (i.e., non-corrugated sections), such as straight section 119 shown in FIG. 16A. Another section 118 having a normal corrugation profile can separate the straight section 119 from the ring portion 120 of the first open end 115, thereby providing flexibility for positioning and coupling the first open end 115 of the drain hose 100 to the pump housing 202 of the drain pump 200 inside the washer. In another embodiment, the section 118 can be formed from a plurality of repeating rings similar to those of the flex-sections 112A, 112B, thereby providing greater flexibility and ease with which the drain hose 100 can be coupled to the pump housing 202 of the drain pump 200 inside the washer.

As shown in FIG. 17, the appliance can be a washer, such as a front load washer 400, having a housing 402 and a door 404 for accessing a rotatable drum that is rotatably mounted in a tub (not shown) within the housing 404.

The exemplary embodiments of the drain hose 100 and the drain hose clip (i.e., drain hose clip) 300 can control the orientation of the drain hose 100 and the drain hose clip 300 with respect to each other, as well as to the opening 408 in the rear panel 406 of the washer housing. The drain hose clip 300 also can reduce or prevent movement of the drain hose 100 into and out of the opening 408 in the rear panel 406 of the washer housing 402, thereby reducing or preventing damage from the drain hose 100 rubbing against the rear panel 406 or the opening 408 of the rear panel 406 of the housing 402.

The present invention has been described herein in terms of several exemplary embodiments. However, modifications and additions to these embodiments will become apparent to those of ordinary skill in the art upon a reading of the foregoing description and could be made without departing from the scope of the invention.

What is claimed is:

1. A drain hose for a household appliance, the drain hose comprising:
a first open end;
a second open end; and
a continuous portion extending from the first open end to the second open end,
wherein the continuous portion includes a first bending portion having a plurality of repeating profiles,
wherein a cross-section of each profile includes a ridge and a trough, and
wherein one of:
the ridge has three predetermined bending points, and
the trough has two predetermined bending points.

2. The drain hose of claim 1, wherein the ridge has three predetermined bending points and the trough has two predetermined bending points.

3. The drain hose of claim 1, wherein the ridge has three predetermined bending points and the trough has three predetermined bending points.

4. The drain hose of claim 1, wherein the cross-section of each profile further includes:
a leg portion connecting the ridge and trough,
wherein a first end of the leg portion is connected to the ridge by a first radius portion, and
wherein a second end of the leg portion is connected to the trough by a second radius portion.

5. The drain hose of claim 1, wherein the ridge includes a first curved portion,
wherein the trough includes a second curved portion, and
wherein the cross-section of each profile further includes:
a tangential portion connecting the first curved portion to the second curved portion;
a first radius transitioning from the first curved portion to a first end of the tangential portion; and
a second radius transitioning from the second curved portion to a second end of the tangential portion.

6. The drain hose of claim 1, wherein the continuous portion includes:
a second bending portion having a plurality of second repeating portions.

7. The drain hose of claim 6, wherein the continuous portion includes:
a straight portion interposing the first bending portion and the second bending portion.

8. The drain hose of claim 7, wherein the straight portion includes a mating surface for receiving a drain hose clip that secures the drain hose to the household appliance.

9. The drain hose of claim 7, wherein the straight portion includes an alignment element that provides a predetermined orientation of the drain hose with respect to a drain hose clip that is coupled to the household appliance.

10. The drain hose of claim 9, wherein the alignment element includes a projection extending from a surface of the straight portion.

11. The drain hose of claim 7, wherein the straight portion includes a plurality of alignment elements for orienting the drain hose with respect to a corresponding plurality of alignment features of a drain hose clip that is coupled to the household appliance.

12. The drain hose of claim 11, wherein the plurality of alignment elements includes a plurality of projections extending from a surface of the straight portion.

13. The drain hose of claim 1, wherein the continuous portion includes:
a first corrugated portion adjacent the first bending portion and between the first bending portion and the first open end.

14. The drain hose of claim 6, wherein the continuous portion includes:
a straight portion coupling the first bending portion to the second bending portion;
a first corrugated portion disposed on an opposite side of the first bending portion from the straight portion and between the first bending portion and the first open end; and
a second corrugated portion disposed on an opposite side of the second bending portion from the straight portion and between the second bending portion and the second open end.

15. The drain hose of claim 1, wherein one of the first open end and the second open end includes a pump alignment element for engaging a corresponding pump alignment feature of a pump housing.

16. The drain hose of claim 1, wherein the household appliance is a washer having a drain pump including a pump housing.

17. A household appliance comprising:
a housing having a front wall and a rear panel, the housing having a door formed in the front wall for accessing an interior of the housing;
a tub disposed inside the housing;
a rotatable drum within the tub and having an axis of rotation, the rotatable drum for receiving laundry through the door;
a drain pump disposed inside the housing; and
the drain hose of claim 1,
wherein the first open end of the drain hose is coupled to the pump housing and the second open end of the drain hose is disposed outside of the housing.

18. The household appliance of claim 17, wherein the housing includes an opening in the rear panel, and
wherein the drain hose extends through the opening.

19. The household appliance of claim 18, wherein the continuous portion of the drain hose includes:
a second bending portion having a plurality of second repeating portions,
wherein the first bending portion is disposed adjacent to the rear panel of the housing and inside the housing, and
wherein the second bending portion is disposed adjacent to the rear panel of the housing and outside the housing.

20. The household appliance of claim 19, wherein the continuous portion of the drain hose includes a straight portion interposing the first bending portion and the second bending portion, and
wherein the straight portion is disposed in the opening of the rear panel.

21. The household appliance of claim 20, wherein the opening forms a fitting support,
wherein the household appliance comprises a clip secured to the fitting support, and
wherein the straight portion includes a mating surface engaging the clip to secure the drain hose to the fitting support of the rear panel.

22. The household appliance of claim 21, wherein the clip includes a first alignment element,
wherein the straight portion of the drain hose includes a second alignment element, and
wherein the first alignment element of the clip engages the second alignment element of the drain hose to provide a predetermined orientation of the drain hose with respect to the clip.

23. The household appliance of claim 17, wherein the household appliance is a washer.
